(19) United States
(12) Patent Application Publication
(10) Pub. No.: US 2010/0096247 A1
(43) Pub. Date: Apr. 22, 2010

(54) ELECTRIC CONTROL MODULE, PARTICULARLY FOR MOTOR VEHICLES

(75) Inventors: Bruno Marie, Creteil (FR); Cedric Chartrain, Creteil (FR)

Correspondence Address: OSHA LIANG L.L.P., TWO HOUSTON CENTER, 909 FANNIN, SUITE 3500, HOUSTON, TX, 77010, US

(73) Assignee: DAV, Creteil (FR)

(21) Appl. No.: 12/520,064

(22) PCT Filed: Dec. 17, 2007
(86) PCT No.: PCT/EP2007/064043

§ 371 Date: Jul. 10, 2009

(30) Foreign Application Priority Data
Dec. 21, 2006 (FR) 06/11301

(51) Int. Cl. H01H 13/702

(52) U.S. Cl. 200/5 A

(57) ABSTRACT

The present invention relates to an electric control module comprising—a substrate (1) for electric circuits,—first electric contact pads (3; 5) provided on a side (2a) of the substrate (1), each contact pad (3; 5) being linked to an associated electric track (7; 9) of the substrate (1) so that each contact pad (3; 5) corresponds to a position on the substrate. The module according to the invention also comprises an surface contact element (23) in the form of a metallic grid connected to the ground, this element (23) covering the side (2a) of the substrate including the contact pads (3; 5) so that a pressure on the surface contact element (23) connects the contact pads (3; 5) at the pressure point to the ground, whereby it is possible to determine the position of the pressure point.

The present invention relates to an electric control module, particularly for motor vehicles.

More specifically, such a module is advantageously applicable to the controls located on the console between the two front seats of a motor vehicle in order, for example, to control air conditioning functions, an audio system, a telephone system or even a navigation system.

The invention can also be applied in a region of the vehicle called the roof or the ceiling which is situated at the level of the normal position of the interior rear view mirror, in order, for example, to control the interior lights, central locking, an opening sunroof, the emergency lights or the ambient lights inside the vehicle.

This module can also be used for the window controls, motorized exterior rear view mirror positioning controls or even motorized seat adjustment controls.

In the motor vehicle domain, the controls of various electric units are conventionally implemented by commutators/switches. However, given the increasing number of electric units to be controlled, multifunction control devices are increasingly being used because of the resulting ergonomic benefits. In practice, using a single control knob, implemented for example in the form of a joystick, associated with a display screen, it is possible to navigate in pop-up menus to control, for example, the air conditioning, the audio system or even a navigation system.

To increase the ergonomic convenience, the use of a touch-sensor technology, alone or complementing such multifunction knobs, can be considered as an interesting development.

In practice, the touch sensors, in particular for the motor vehicle domain, have made significant progress. A technology using pressure-sensitive resistors (also known as FSR, standing for “force-sensing resistor”) is increasingly outstripping other equivalent technologies, such as, for example, capacitive technologies or even optical technologies thanks to its ease of implementation and its robustness.

Such sensors are, for example, known as “digitizer pads”, and, for the prior art, the following documents can be cited: U.S. Pat. No. 4,810,992, U.S. Pat. No. 5,008,497, FR 2683649 or even EP 0 541 102.

These sensors comprise flexible semiconductive layers sandwiched between, for example, a conductive layer and a resistive layer. By exerting a pressure on the FSR layer, its ohmic resistance reduces, so making it possible, by applying a suitable electric voltage, to measure the pressure applied and/or the location of the point where the pressure is exerted.

According to a different design of the FSR technology, the touch sensor comprises two flexible substrate sheets spaced apart by elastic spacers and bearing, on mutually facing sides, elements making it possible to make an electric contact when the sensor is compressed (see for example EP 1 429 355 and EP 1 429 356).

However, the known sensors are fairly costly which acts as a break on the application of touch technologies in motor vehicles.

Moreover, known from document U.S. Pat. No. 5,283,558 is a touch pad with a simplified and inexpensive technology.

A first dielectric substrate carries parallel conductive tracks forming columns of a Cartesian frame of reference. The outputs of these tracks are linked to an associated resistive strip. Parallel to these columns, arranged on the same substrate, are parallel tracks linked to the ground. Then, this substrate is covered by a second dielectric substrate on which are arranged parallel conductive tracks forming rows of a Cartesian frame of reference and which are perpendicular to the tracks forming columns. The outputs of these tracks forming the rows are also linked to an associated resistive strip. Between the two substrates there is a spacer for preventing, in the rest position, any contact between the different tracks.

By pressing on this known pad, a column conductive track and a row conductive track are linked at the pressure point to a ground track. Thus, with an electric circuit in the manner of a divider bridge for the two resistive strips, it is possible to measure a change of resistance and to deduce therefrom the position in x and y coordinates of the pressure point.

However, the applicant has observed a number of drawbacks for this known pad.

In the motor vehicle domain, it is important for the electric components to be fairly insensitive to the electromagnetic interference forces to which a vehicle can be exposed, either because of its own components when operating (for example, the alternator or an electric engine that is operating), or because of its environment (for example, when the vehicle passes under a high voltage line or close to a cell phone relay antenna). Now, in the known touch pad, the x and y tracks have little protection and pick up all the electromagnetic interferences just like antennas, which can, in certain situations, cause malfunctions.

In addition, the overlapping of the conductive tracks where the rows and columns cross is very weak so that dependability is not assured. In practice, with the configuration of this pad as described, it is found that, in certain cases, a pressure does not simultaneously ground a row track and a column track so that the position of the pressure cannot be determined. In particular, in a motor vehicle where a certain number of controls are applied blind by a driver, this uncertainty is unacceptable because, in the event of a malfunction of this type, the attention of the driver is diverted and he has to repeat his control action which, depending on the driving situation, can prove highly dangerous.

Finally, it is shown that the use of a resistive strip at the output of the conductive tracks creates detection difficulties at the resolution level, because, for the column tracks and the row tracks connected to one end of the resistive strip, the voltage difference at the output between two adjacent tracks becomes very low compared to the voltage difference at the output between two row tracks at the opposite end, which can also lead to unacceptable malfunctions.

The present invention aims to propose an improved electric control module.

According to a first aspect, the aim is to reduce the influence of the antenna effect and therefore the influences of a disturbing electromagnetic environment.

According to a second independent aspect, the aim is to increase the dependability of the electric control module.

According to a third independent aspect, the aim is to propose an electric control module with a resolution that is distributed equally over the entire touch surface of the module.

To this end, the subject of the invention is an electric control module comprising
a substrate for electric circuits,
first electric contact lands provided on a side of the substrate, each contact land being linked to an associated electric track of the substrate so that each contact land corresponds to a position on the substrate,
   characterized in that it also comprises:
an elastically deformable surface contact element connected to the ground, this element covering the side of the substrate including the contact lands so that a pressure on the surface contact element links the contact lands at the pressure point to the ground, so making it possible to determine the position of the pressure point.

By being linked to the ground, the surface contact element advantageously acts as a protective shield against electromagnetic interference.

Furthermore, and independently of its protective shield role, this surface contact element ensures an improved dependability by a better electrical contact between the contact lands and the surface contact element.

Finally, the resistors of a divider bridge to which the outputs of the electric tracks are connected, are chosen according to a recursive series defining output voltage levels that are substantially equidistant between two rows and/or between two columns of the Cartesian frame of reference. A resolution that is evenly distributed over the entire module is therefore obtained.

Other features and benefits of the invention will emerge from the following description, given by way of example, but in a non-limiting way, in light of the appended drawings in which:

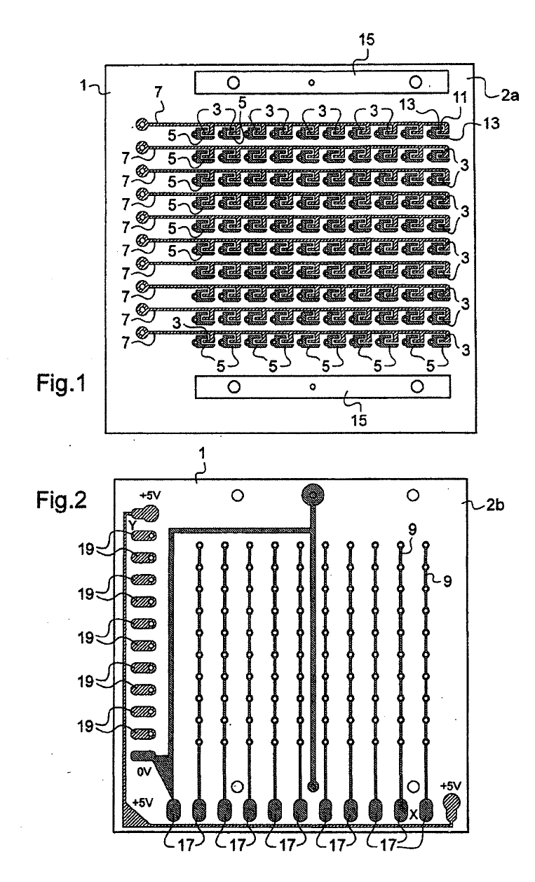

FIG. 1 is a plan view of a printed circuit board of an electric control module according to the invention,

FIG. 2 is a bottom view of the printed circuit board of FIG. 1,

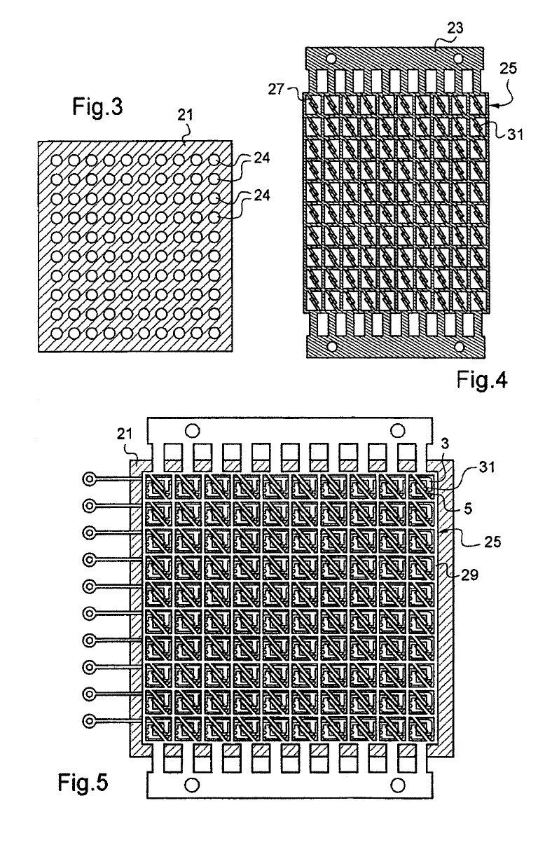

FIG. 3 is a diagrammatic view of an insulating layer intended to be applied to the printed circuit board of FIG. 1,

FIG. 4 is an example of a metallic grid intended to be applied to the insulating layer of FIG. 3,

FIG. 5 is a plan view of the printed circuit board of FIG. 1 on which the insulating layer of FIG. 3 and the metallic grid of FIG. 4 are placed,

FIG. 5a is an enlarged detail view of FIG. 5,

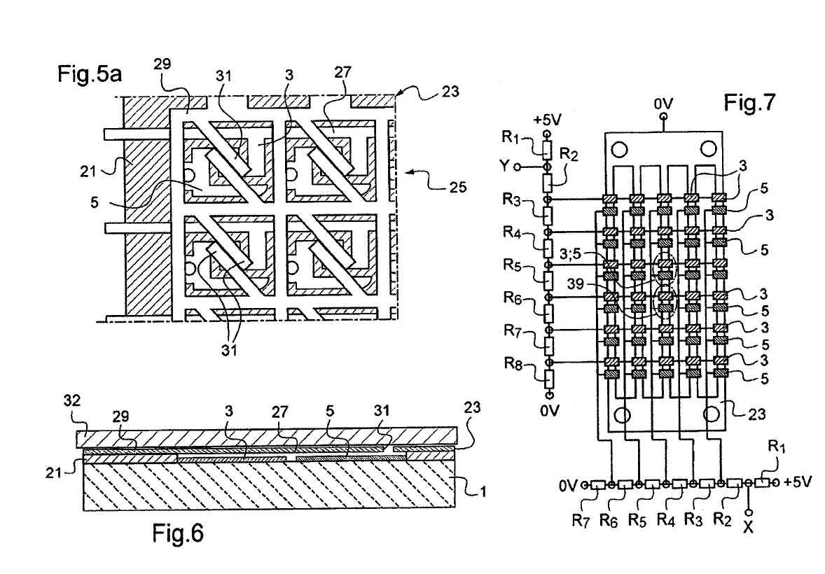

FIG. 6 is a cross-sectional view of the electric control module according to the invention,

FIG. 7 is a circuit diagram to explain the connection and the operation of the control module according to the invention, the control module having a reduced size compared to the module of FIGS. 1 to 6,

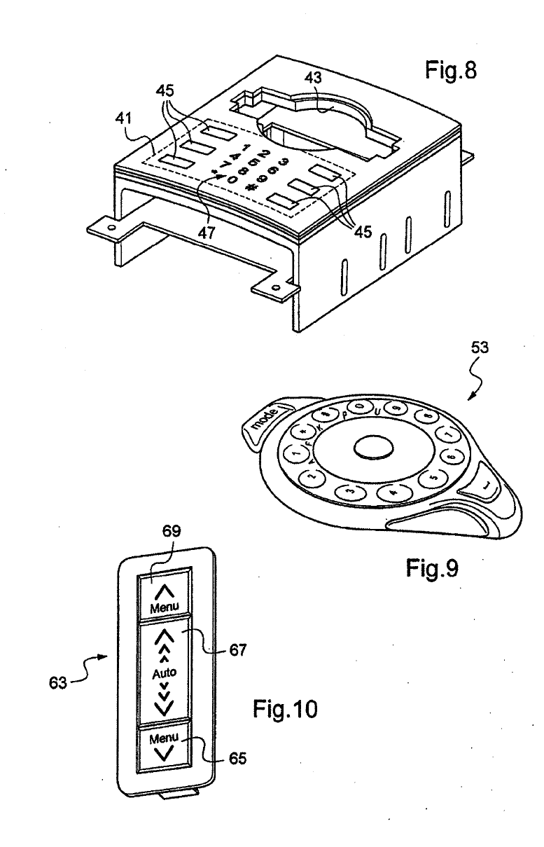

FIG. 8 is a perspective view of a first application of a control module according to the invention,

FIG. 9 is a perspective view of a second application of a control module according to the invention, and

FIG. 10 is a perspective view of a third application of a control module according to the invention.

The invention relates to an electric control module, and more particularly to a touch control module, that is, operated by the pressure of a finger of a user.

Such a module can advantageously be used in the motor vehicle domain for any “surface” type control, that is, a control for which a finger is moved for example over a control surface or for which the control is produced by a simple pressure on a control surface.

Examples that can be cited include motorized seat controls, door window controls, motorized exterior mirror controls, ceiling controls such as the interior lighting controls, sunroof opening controls, air conditioning controls, multifunction telephony, navigation or even audio system controls, and so on.

Referring to FIGS. 1 to 7, there now follows a detailed description of the structure and the operation of the electric control module according to the invention. Then, with reference to FIGS. 8 to 10, possible applications of the module according to the invention will be described by way of example and in a non-limiting manner.

As will be seen in FIG. 1, the electric control module comprises a substrate 1 for electric circuits such as, for example, a printed circuit board (PCB).

As a variant, a flexible electric circuit (or “flex circuit”) can be provided, arranged on a base having a flat or curved surface. Thus, touch surfaces can be produced that are not flat, which is an advantage when it comes to the design. By using such a flexible circuit, it is possible for example to produce a touch surface which shapes itself fully to the shape of a rounded dashboard.

The side 2a of the printed circuit board 1 represented in FIG. 1 supports first contact lands 3 and second contact lands 5 arranged in rows and columns according to a Cartesian frame of reference.

Obviously, the arrangement according to a Cartesian frame of reference in rows and columns is just one exemplary embodiment. Depending on the electric controls to be applied, it is possible to provide for other frames of reference such as an angular frame of reference whereby the contact lands are arranged in circle segments for example to reproduce the control of a rotary knob.

Preferably, each contact land 3 and 5 has a general U shape.

Thus, FIG. 1 shows ten rows of contact lands 3, each row comprising ten individual contact lands linked to an associated electric track 7.

Similarly, the module has ten columns of contact lands 5, each column comprising ten individual contact lands linked to an associated electric track 9 located on the bottom side 2b of the printed circuit board 1 (see FIG. 2 showing this bottom side), that is, the side opposite to that supporting the contact lands.

There are therefore obtained 100 pairs of adjacent contact lands which are supported by the same side 2a of the substrate 1 and which are arranged according to a Cartesian frame of reference, of which the first contact lands 3 of a pair form rows and the second contact lands 5 of a pair form columns. To determine the position of a pressure, the columns give, for example, an X coordinate position whereas the rows detect the Y coordinate position. The exact position of a press on the module according to the invention is therefore determined by the pairing (X, Y).

Preferably, the adjacent electric contact lands 3 and 5 of a pair are interleaved, for example, as can be seen in FIGS. 1 and 5a, so that the U-shaped contact lands of a pair are arranged head to tail, staggered so that a branch 11 of a first contact land 3 is surrounded by the branches 13 of the second adjacent contact land 5.

Moreover, the substrate 1 also has two ground contact strips 5 which are arranged on either side of the field of pairs of adjacent contact lands.

In FIG. 2, which shows the rear side of the printed circuit board 1, it can be seen that each track 9 culminates in a connection area 17, just as the tracks culminate via through contacts at the connection areas 19.

These connection areas 17 and 19 are linked by resistors as is shown in FIG. 7 for a control module of reduced size but having the same operation (five by six, in other words 30 adjacent contact lands) in order to form a divider bridge.

An electrically insulating member 21 (see FIG. 3) is applied to the side 2a of the printed circuit board 1 represented in FIG. 1. This member 21 forms a spacer and is used to maintain, in the rest position, a predefined distance between the contact lands 3 and 5 and a surface contact element 23 represented in FIG. 4 which will be described in detail hereinbelow.

Preferably, the spacer-forming member is formed by an insulating layer such as a lacquer of a thickness advantageously between 50 μm and 100 μm, deposited on the printed circuit board except at the level of the pairs of adjacent electric contact lands. In FIG. 3, this is represented by holes 24, the position of which is centered on adjacent contact lands.

According to the invention, the electric control module comprises a surface contact element 23 (FIG. 4) which is elastically deformable and which is linked to the ground. This contact element then forms a shield against any interfering electromagnetic radiation and significantly improves the dependability of the control module according to the invention.

As can be seen in FIG. 5, this element 23 covers the side of the substrate 1 having the contact lands 3, 5 so that a pressure on the surface contact element 23 links the contact lands 3, 5 at the pressure point to the ground so making it possible to determine the position of the pressure.

To this end, the surface contact element 23 is made of metal, for example in the form of a metallic grid (FIG. 4) connected to the ground at the level of the strips 15 (see FIG. 1). This grid is, for example, produced by stamping.

Preferably, the grid 23 comprises, for each pair of adjacent contact lands, an individual cell 25 (FIG. 5a shows four individual cells) with at least one electric contact 27 intended to come into contact with each of the adjacent contact lands of a pair when a pressure is applied.

Advantageously, each individual cell 25 is formed by a frame 29 resting on the spacer-forming insulating member 21 and at least one electric contact 27 in the form of a tab 31, the free end of which moves between a rest position in which it is raised, and an active position, for example activated by a pressure, in which it makes an electric contact with the adjacent contact lands 3, 5 to link the latter to the ground (see FIG. 5).

Shrewdly, each cell, preferably square shaped, comprises two tabs 31 arranged in a staggered manner and parallel to the diagonal of the individual cell 25, starting from the opposite sides of the individual cell 25.

As a variant, it is possible to provide for the surface contact element to include a layer of a conductive material connected to the ground, such as a skin made of an elastomer, preferably of silicone, filled with conductive particles, or such as a conductive polymer.

FIG. 6 shows a transverse cross-sectional view of the control module at the level of an individual cell 25.

Furthermore, a skin 32 for transmitting a pressure force covers said surface contact element 23. Preferably, the side of the skin 32 facing the contact element is smooth.

According to a variant that is not represented, the side of the skin 32 facing the surface contact element 23 has, at the level of each pair of adjacent contact lands, a concavity making it possible to obtain a blister effect.

To be able to determine the position of a pressure, the electric tracks 7 and 9 associated with the columns and with the rows are respectively electrically linked by an associated set of resistors forming a divider bridge as is represented in a circuit diagram of FIG. 7.

In the interests of clarity, the number of contact lands 3 and 5 has been reduced in this figure, as was explained hereinabove.

Advantageously, the resistors of the divider bridge are chosen according to a recursive series defining output voltage levels that are substantially equidistant between two rows or between two columns of the Cartesian frame of reference.

Physically, for a number N of positions (N being a natural number) on a row or column, there are N+2 resistors and the value of R₁ is set.

Then, to ensure a uniform distribution of the voltages, each resistance n is calculated according to the following recursive formula:

$${R}_{n} = \frac{{\sum }_{i = 1}^{n - 1} {R}_{i}}{N + 1}$$

Thus, a pressure on the module reliably delivers the X and Y coordinates.

Moreover, the control module comprises a microcontroller for analyzing the signals originating from the electric tracks. This analysis can be static, that is, only the position of the pressure is determined, or dynamic, that is, the trend of the pressure position is followed to deduce therefrom a control of an electric or electronic member.

The control module therefore operates as follows:

In the rest position, all the tabs 31 of the grid 23 are raised. Since the grid is linked to the ground, it serves as an effective protective screen against electromagnetic radiation. Referring to the exemplary circuit of FIG. 7, the “X” signal corresponds to a voltage delivered by a divider bridge:

$${U}_{Xidle} = \frac{{\sum }_{i = 2}^{7} {R}_{i}}{{\sum }_{i = 1}^{7} {R}_{i}} {U}_{pwr sup}$$

where U_{pwr sup} is the power supply voltage, for example 5V.

The “Y” output voltage in the rest position is calculated in a similar manner:

$${U}_{Yidle} = \frac{{\sum }_{i = 2}^{8} {R}_{i}}{{\sum }_{i = 1}^{8} {R}_{i}} {U}_{pwr sup}$$

If we now consider a pressure on the control module according to the invention, for example on the adjacent contact lands indicated in FIG. 7 by the reference number 39, the “X” signal corresponds to a voltage delivered by a divider bridge:

$${U}_{X} = \frac{{\sum }_{i = 2}^{4} {R}_{i}}{{\sum }_{i = 1}^{4} {R}_{i}} {U}_{pwr sup}$$

where U_{pwr sup} is the power supply voltage, for example 5V.

The “Y” output voltage in the rest position is calculated in a similar manner:

$${U}_{Y} = \frac{{\sum }_{i = 2}^{5} {R}_{i}}{{\sum }_{i = 1}^{5} {R}_{i}} {U}_{pwr sup}$$

There is also another benefit of the control module according to the invention to be found in the case of a double pressure on the touch surface. In practice, the behavior of the electric control module according to the invention is entirely predictable, because it always delivers a single position corresponding to the one located closest to the power supply potential of the device.

FIG. 8 shows an electric control module 1 according to the invention which has a generally parallelepipedal form, intended to be mounted in a motor vehicle, preferably on the center console between the two front seats.

Obviously, other shapes and other locations can be considered depending on the controls required and their usual placement.

The module comprises a touch control surface 41 indicated by broken lines and, optionally, a housing 43 to receive, for example, a multifunction knob such as a joystick.

Inside the touch control surface 41, six touch areas are defined for selecting electric or electronic units (for example: “GENERAL MENU”, “RADIO”, “CD”, “NAVIGATION”, “TELEPHONE” and “AIR CONDITIONING”) and a conventional alphanumeric keyboard 47 with twelve touch keys (the numerals “0” to “9” and the symbols “#” and “*”). Each area or key comprises a symbol or a letter or numeral inscription related to the function to be controlled.

According to the invention, the touch area is implemented by an electric control module according to the invention as described in relation to FIGS. 1 to 7.

Although the control module has been described with rows and columns in two dimensions “X” and “Y”, a simplified module can be provided with only one row of electric contact lands covered by an elastically deformable surface contact element that is linked to the ground. The row can take any desired form, in particular a predetermined form such as a straight or wavy line or a circle. The surface contact element therefore covers, as described in relation to FIGS. 1 to 7, the side of the substrate having the contact lands so that a pressure on the surface contact element links the contact lands at the pressure point to the ground, so making it possible to determine the position of the pressure point.

Thus, FIG. 9 shows a perspective view of an electric control module 1 which has a touch area 53 of circular shape intended to handle telephony features.

To this end, the touch area 53 comprises pictograms with the numerals “0” to “9” and the symbols “*” and “#”.

This touch area 53 can, for example, be implemented using the electric control module according to the invention by arranging the contact lands in a circle.

Another example of physical application is shown in FIG. 10 which shows a control module according to the invention intended to handle electric door window controls.

The touch area 63 implemented according to the invention comprises a field 65 for lowering a window by a simple pressure, a field 67 for being able to apply sliding-type controls, that is, the direction and the trend of the change of position of a finger in time is determined and a corresponding electric control is applied, and a field 69 for raising a window by a simple pressure.

In practice, the control module does not only make it possible to simply determine the pressure position, that is, the location, but, depending on the movements for example of a finger in time, corresponding controls can be deduced therefrom.

It will therefore be understood that the control module according to the invention makes it possible to produce an inexpensive touch sensor which is nonetheless reliable in terms of operation, and in particular one that is protected against interfering electromagnetic waves.

1. An electric control module comprising
a substrate (1) for electric circuits,
first electric contact lands (3; 5) provided on a side (2a) of the substrate (1), each contact land (3; 5) being linked to an associated electric track (7; 9) of the substrate (1) so that each contact land (3; 5) corresponds to a position on the substrate, characterized in that it also comprises a surface contact element (23) in the form of a metallic grid connected to the ground, this element (23) covering the side (2a) of the substrate including the contact lands (3; 5) so that a pressure on the surface contact element (23) links the contact lands (3; 5) at the pressure point to the ground, so making it possible to determine the position of the pressure point.

2. The electric control module as claimed in claim 1, characterized in that electric contact lands (3; 5) provided on a side of the substrate are arranged in a line of a predetermined form.

3. The control module as claimed in claim 2, characterized in that the line is straight, wavy or in the form of a circle.

4. The electric control module as claimed in claim 1, characterized in that it includes on the same side (2a) of the substrate (1) second electric contact lands (5) forming pairs with the first contact lands (3), each contact land of a pair being linked to an associated electric track of the substrate (1) so that each pair of adjacent contact lands (3, 5) corresponds to a pair of coordinates of a predefined frame of reference making it possible to locate its position on the substrate (1) when the surface contact element links, at a pressure point, two contact lands (3, 5) of a pair to the ground.

5. The electric control module as claimed in any one of claims 1 to 4, characterized in that the substrate (1) for electric circuits is a printed circuit board.

6. The electric control module as claimed in any one of claims 1 to 4, characterized in that the substrate comprises a flexible electric circuit arranged on a base having a flat or curved surface.

7. The electric control module as claimed in any one of claims 1 to 6, characterized in that the first contact lands (3) of a pair are linked to associated electric tracks (7) arranged on the same side (2a) and in that the second contact lands (5) of a pair are linked to electric tracks (9) arranged on the opposite side (2b) to that bearing the contact lands (3, 5).

8. The electric control module as claimed in any one of claims 1 to 7, characterized in that the adjacent electric contact lands (3, 5) of a pair are interleaved.

9. The control module as claimed in claim 8, characterized in that each contact land (3; 5) has a general U-shape.

10. The control module as claimed in claim 9, characterized in that the U-shaped contact lands (3; 5) of a pair are arranged head to tail, staggered so that a branch (11) of a first contact land (3) is surrounded by the branches (13) of the second adjacent contact land (5).

11. The control module as claimed in any one of claims 1 to 10, characterized in that the adjacent electric contact lands (3, 5) are arranged according to a Cartesian frame of reference in which the first contact lands (3) of a pair form rows and the second contact lands (5) of a pair form columns.

12. The control module as claimed in claim 11, characterized in that the electric tracks associated with the columns (5) and with the rows (3) are respectively electrically interlinked by an associated set of resistors (R₁, R₂, R₃, R₄, R₅, R₆) forming a divider bridge circuit.

13. The control module as claimed in claim 12, characterized in that the resistors (R₁, R₂, R₃, R₄, R₅, R₆) of the divider bridge are chosen according to a recursive series defining output voltage levels that are substantially equidistant between two rows or between two columns of the Cartesian frame of reference.

14. The control module as claimed in any one of claims 1 to 13, characterized in that an electrically insulating and spacer-forming member (21) is used to maintain, in the rest position, a predefined distance between the contact lands (3, 5) and the surface contact element (23).

15. The control module as claimed in claim 14, characterized in that the spacer-forming member (21) is formed by an insulating layer deposited on the printed circuit board except at the level (24) of the pairs of adjacent electric contact lands (3, 5).

16. The control module as claimed in claim 15, characterized in that the insulating layer (21) is a lacquer.

17. The control module as claimed in claim 15 or 16, characterized in that the insulating layer (21) has a thickness of between 50 μm and 100 μm.

18. The control module as claimed in any one of claims 1 to 17, characterized in that the surface contact element comprises a layer of a conductive material connected to the ground.

19. The control module as claimed in claim 18, characterized in that the layer of a conductive material is an elastomer skin, preferably silicone, filled with conductive particles.

20. The control module as claimed in claim 19, characterized in that the layer of a conductive material is made of a conductive polymer.

21. The control module as claimed in any one of claims 1 to 20, characterized in that the grid comprises, for each pair of adjacent contact lands (3, 5), an individual cell (25) with at least one electric contact (27) intended to come into contact with each of the adjacent contact lands (3, 5) of a pair.

22. The control module as claimed in claim 21, taken together with one of claims 14 to 17, characterized in that each individual cell (25) is formed by a frame (29) resting on the spacer-forming insulating member (21) and at least one electric contact (27) in the form of a tab (31), the free end of which moves between a rest position in which it is raised, and an active position, for example activated by a pressure, in which it makes an electric contact with the adjacent contact lands (3, 5) to link the latter to the ground.

23. The control module as claimed in claim 22, characterized in that each individual cell (25), preferably square shaped, comprises two tabs (31) arranged in a staggered manner and parallel to the diagonal of the individual cell (25).

24. The control module as claimed in any one of claims 1 to 23, characterized in that the metallic grid (23) is produced by stamping.

25. The control module as claimed in any one of claims 1 to 24, characterized in that it also comprises a skin (32) for transmitting a pressure force, covering said surface contact element (23).

26. The control module as claimed in claim 25, characterized in that the side of the skin (32) facing the contact element is smooth.

27. The control module as claimed in claim 26, characterized in that the side of the skin (32) facing the surface contact element has, at the level of each pair of adjacent contact lands, a concavity making it possible to obtain a blister effect when a pressure is applied.

28. The control module as claimed in any one of claims 1 to 27, characterized in that it comprises a microcontroller for analyzing the signals originating from the electric tracks.
